(19) United States
(12) Patent Application Publication
(10) Pub. No.: US 2023/0275893 A1
(43) Pub. Date: Aug. 31, 2023

(54) EXTENDING OIDC AUTHENTICATION TO SERVICE ACCOUNT FOR DUAL AUTHORIZATION

(71) Applicant: Dell Products L.P., Round Rock, TX (US)

(72) Inventors: Anurag Sharma, Cedar Park, TX (US); Senthilkumar Ponnuswamy, San Jose, CA (US); Karimuthu Rengasamy, Lafayette, CO (US)

(21) Appl. No.: 17/652,609

(22) Filed: Feb. 25, 2022

(51) Int. Cl. H04L 9/40

(52) U.S. Cl. CPC H04L 63/0869; H04L 63/083

(57) ABSTRACT

One example method includes receiving, by an identity and access management module, a request from a first service to validate a user token, and the request includes a service token. The method further includes performing, by the identity and access management module, a validation process on the user token and, when the validation process is successful, generating, by the identity and access management module, an access token that includes the user token and the service token. Finally, the method includes transmitting, by the identity and access management module to the first service, the access token, wherein the access token is usable by the first service to gain access to a second service upon successful validation, by the second service, of the access token.

### FIELD OF THE INVENTION

Embodiments of the present invention generally relate to authentication processes. More particularly, at least some embodiments of the invention relate to systems, hardware, software, computer-readable media, and methods for authenticating a user and one or more services in a microservices based architecture.

### BACKGROUND

In a microservices based architecture, a user may request access to a web-based application that comprises, and/or is backed by, one or microservices to perform various functions of the application. In order to use the application, the user may have to successfully complete an authentication process that may involve, upon successful authentication, creation of a user token that can be passed from the application to a microservice implicated by that application. The microservice, as well, may have to obtain a service token that enables the microservice, or calling microservice, to call one or more other microservices, the called microservices, as may be needed to perform the functions of the application. This approach to authentication has proven to be problematic in at least some respects.

For example, the service token passed by the calling microservice to the called microservice does not indicate that the calling microservice is calling on behalf of the user. That is, the called microservice may only validate the service token received from the calling microservice and, upon successful validation, may be accessible by the calling microservice. In this case, the user token may evaluated only by the calling microservice, and not by the called microservice. Thus, the called microservice may be accessed even if the user is not authorized to use that microservice for some reason.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a comparative example and operating environment.

FIG. 2 discloses aspects of an example approach to authentication in an example operating environment.

FIG. 3a discloses an example authentication process according to some embodiments.

FIG. 3b discloses an example process for refreshing a token according to some embodiments.

FIGS. 4a and 4b disclose aspects of example tokens according to some embodiments.

FIG. 5 discloses an example authentication method.

FIG. 6 discloses aspects of an example computing entity operable to perform any of the claimed methods, processes, and operations.

### DETAILED DESCRIPTION OF SOME EXAMPLE EMBODIMENTS

Embodiments of the present invention generally relate to authentication processes. More particularly, at least some embodiments of the invention relate to systems, hardware, software, computer-readable media, and methods, for authenticating a user and one or more services in a microservices based architecture.

In general, example embodiments of the invention may provide for the creation and use of a single token [user+service], such as a JSON (JavaScript Object Notation) Web Token (JWT) for example, that may enable a called service to authenticate both (1) a user who invoked an application that employs the called service for execution of a function, and (2) a calling service that may also be employed by the application, and which calls the called service in connection with the operation of the application. In some embodiments, the single token [user+service] may expire after a predetermined time. If this occurs, the calling service may, if the token contains a user profile, check user authorization again, or, if the token contains only a service profile, check only that the called service is authorized to be used.

As used herein, a ‘token’ embraces, but is not limited to, a cryptographically signed, tamperproof entity containing a profile. Thus, a user token may comprise a user profile, and a service token may comprise a service profile. A user profile may encapsulate user attributes such as, but not limited to, a user name, email, organization, and role in the organization, for example. Such attributes may be referred to herein as ‘claims’ of a user token. A user token may have other claims as well, such as, but not limited to, claims representing attributes of the token, such as the identity of the token issuer, and ‘iat’ (issued at). A service profile may encapsulate service attributes such as, but not limited to, the name of the service, functions performed by the service, and any services upon which the service is dependent for carrying out its functions. These attributes of a service profile may be referred to as ‘claims’ of a service profile.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

For example, an embodiment of the invention may enable a called service to be aware that a calling service is calling on behalf of a user who has invoked the operation of an application that employs the calling service and the called service. As another example, an embodiment may enable a called service to check the authorization of a user, and the authorization of a calling service. In another example, an authorized user may be permitted to use a service that was called by a calling service which the user is authorized to use. As a final example, an embodiment may enable, upon successful authorization, reuse of an expired token. Various other features and advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of a Comparative Example

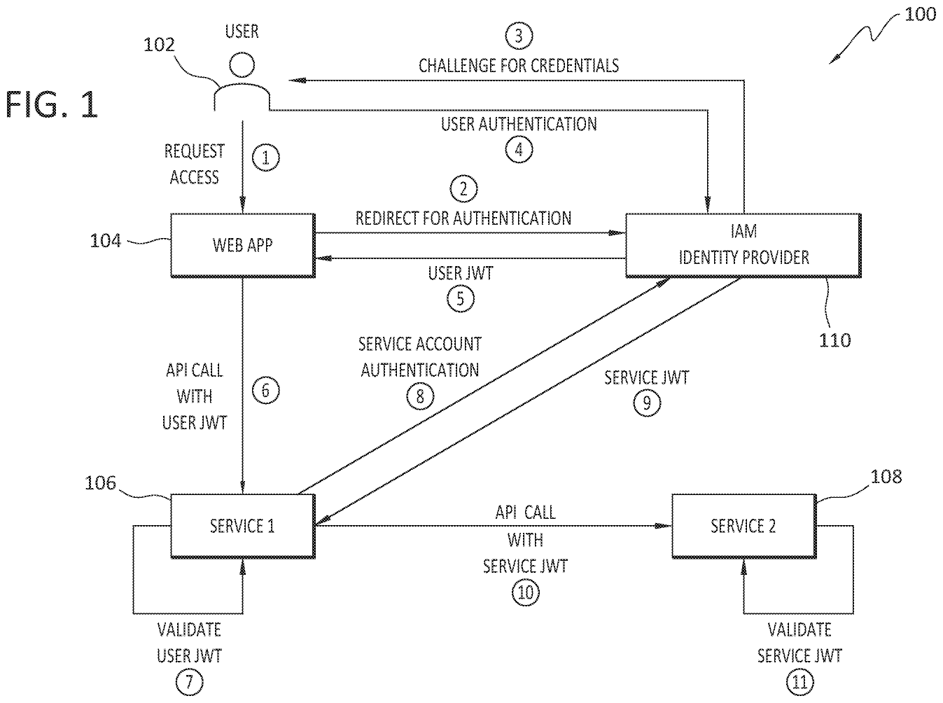

With attention now to FIG. 1, aspects of an example operating environment 100 and operations are presented for the sake of comparison with example embodiments of the invention. Part, or all, of the example operating environment 100 may be employed by some embodiments of the invention. However, it is noted that FIG. 1 and the discussion are not intended to limit the scope of the invention in any way.

In the example of FIG. 1, the operating environment 100 may comprise a user 102, one or more web applications 104, which may each be associated with one or more services 106 and 108. The operating environment may also include an IAM (Identity Access Management) identity provider 110. The web application 104, which may be invoked or instantiated at the request of the user 102, may be a containerized application that relies for its functionality on the operation of the services 106 and 108, which may comprise microservices that each run in a respective container. In some instances, the service 106 may take the form of an API (Application Program Interface) gateway rather than a microservice. Thus, the operating environment 100 may take the form of a container-based architecture, such as Kubernetes or Docker, for example.

Operationally, the user 102 may request access (1) to the web application 104 which, in response to that request, may redirect (2) the request to the IAM identity provider 110 for authentication of the user. The IAM identity provider 110 may challenge (3) the user for user credentials, such as a username and password for example, and the user may respond by providing (4) the requested credentials. After receipt of the necessary credentials, the IAM identity provider 110 may generate, and transmit (5) to the web application 104, a user token, such as a user JWT for example.

After receipt of the user token, the web application 104 may then transmit (6) an API call, along with the user token, to the service 106, which may then perform (7) a validation process on the user token, which validation process may comprise checking, by the service 106, to determine if the user 102 is authorized to use the service 106. If the validation process (7) is successful, the service 106 may then request (8) service account authentication by the IAM identity provider 110. Upon successful authentication, the IAM identity provider 110 may provide (9) a service token, just as a service JWT, to the service 106. The service 106 may then transmit (10) the API call, along with the service token, to the service 108, which may then perform (11) a validation process on the service token. If that validation process is successful, the service 108, or called service, may be invoked and used by the service 106, or the calling service.

The approach outlined in FIG. 1 may be problematic however. For example, based on the service JWT, the service 108 does not know that the service 106 is calling it, that is, service 108, on behalf of the user. Thus, if the user 102 is not authorized to use the service 108, the service 108 will be unable to prevent such access since the service 108 lacks awareness that the API call transmitted (10) by the service 106 is associated with the user 102. This lack of awareness is due to the fact that the service 108 receives only a service token, and not a user token. In order to overcome this problem, the service 108 would have to check authorization not only for the service token, but also the user token.

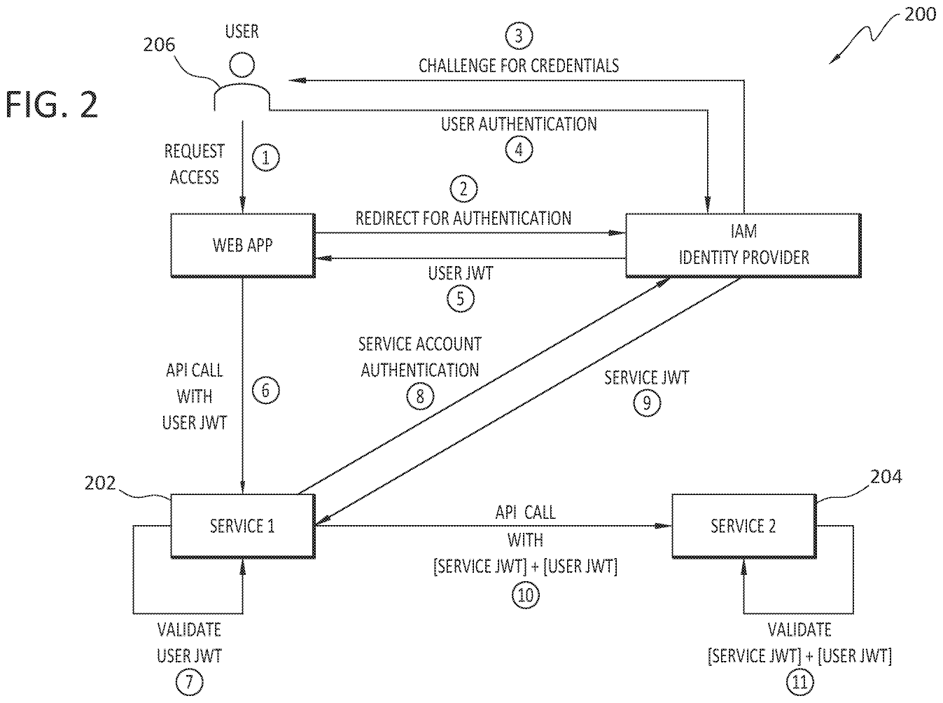

Given the potential problems such as those noted in the discussion of FIG. 1, an alternative approach might be to communicate both a user token and a service token from a calling service to a called service. One such alternative approach is disclosed in FIG. 2. Except as may be noted hereafter, the structure and operation of the example operating environment 200 may be similar, or identical, to the structure and operation of the example operating environment 100. Thus, the following discussion addresses only selected differences.

Particularly, at (10), and in contrast with the example method of FIG. 1, the service 202 may transmit an API call, along with both a service token and a user token, to the service 204. The service 204 may then perform a validation process (11) on both the service token and the user token. Thus, the service 204 may validate both the service 202 and the user 206. The validation (11) of the service 202, based on the service token, may be performed by the service 204 as in the example of FIG. 1.

Like the approach outlined in FIG. 1 however, the method of FIG. 2 is problematic. For example, there is no correlation between the service token (Service JWT) and the user token (User JWT). Thus, a bad actor may be able to impersonate the user 206 and employ a variety of different services because there is nothing to tie that user to any particular service or services. It is enough, to enable impersonation, that the user be authorized. On the other hand, if there were a link between the user 206 and particular services authorized to be employed by the user 206, then only those services could be used if they, and the user, were authenticated.

A related problem is that the user token may be expired. However, if the service 204 is not aware of this expiration, access to the service 204 may nonetheless be granted to the user 206. Further, there is a risk of man-in-the-middle attack by a bad actor who may replay the call (10) to the service 204 using an expired user token from some unknown session, such as a session involving a user with high level privileges. Such an attack may lead to authorization of a user who should not have been authorized, and may also result in misleading audit information, since access was gained by an user who should not have been authorized. Finally, an audit log for the method of FIG. 2 would not be centralized, but instead would depend on the implementation of the service 204.

### B. Aspects of Some Example Embodiments

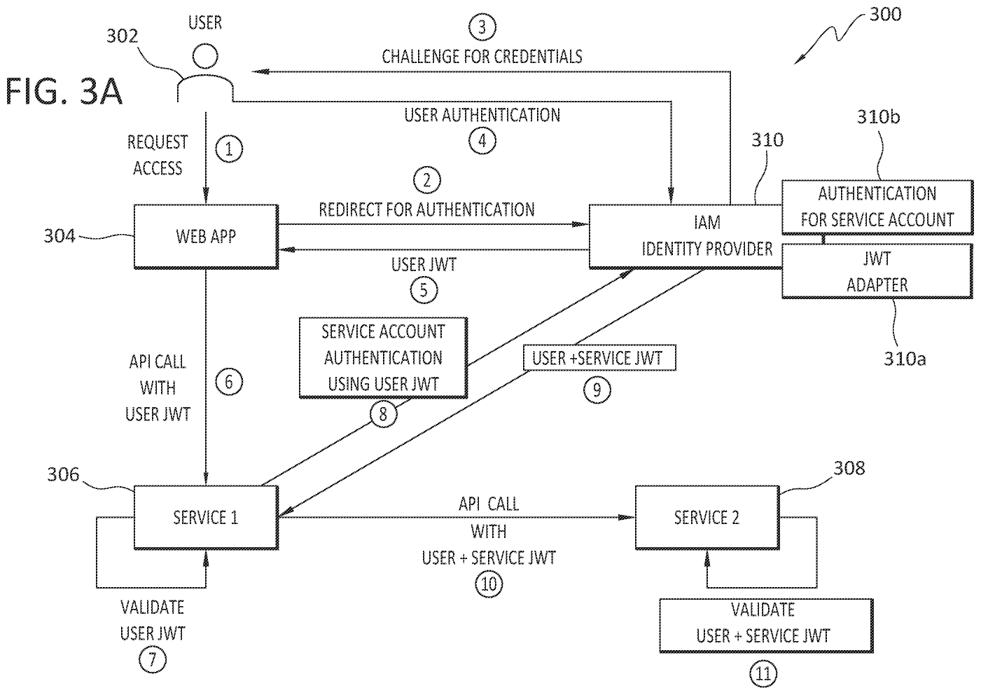

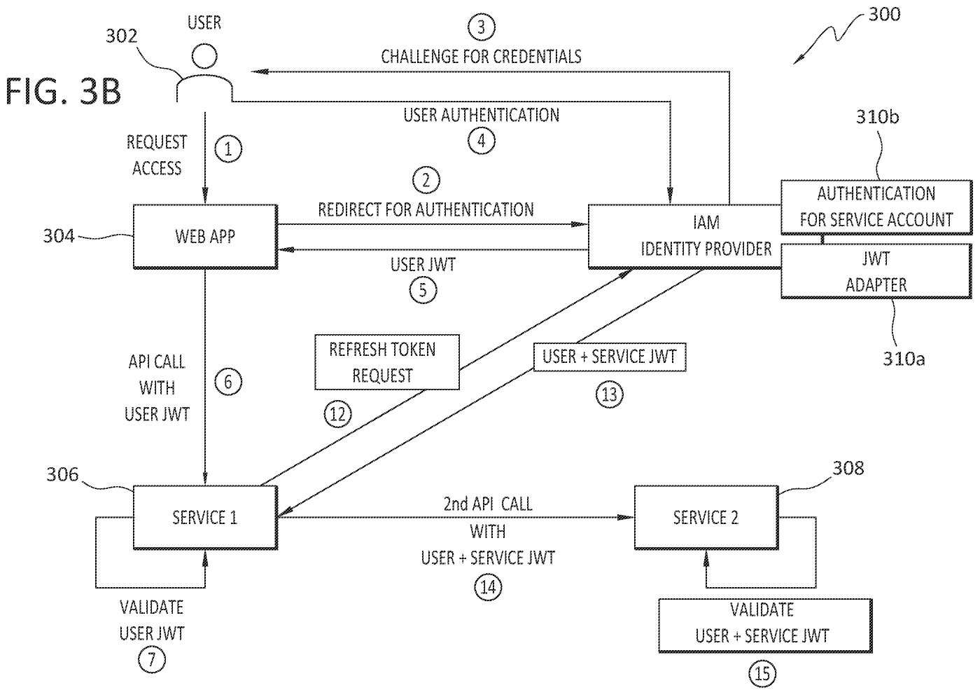

The methods and/or architectures disclosed in FIGS. 1 and 2 may be employed in whole, or in part, in some embodiments of the invention. Following is a discussion, with reference to FIG. 3a, of further aspects of some example embodiments of the invention. Except as may be noted hereafter, the structure and operation of the example operating environment 300 of FIG. 3a may be similar, or identical, to the structure and operation of the example operating environment 100 and/or example operating environment 200. For example, processes (1) through (7) of FIG. 3a may be similar, or identical, to respective processes (1) through (7) of FIGS. 1, and 2. Thus, the following discussion addresses only selected aspects of FIG. 3a.

In the example of FIG. 3a, the operating environment 300 may comprise one or more users 302, one or more web applications 304, which may each be associated with one or more services 306 and 308. The operating environment may also include an IAM (Identity Access Management) identity provider 310. The web application 304, which may be invoked or instantiated at the request of the user 302, may be a containerized application that relies for its functionality on the operation of the services 306 and 308, which may comprise microservices that each run in a respective container. In some instances, the service 306 may take the form of an API (Application Program Interface) gateway rather than a microservice. Thus, the operating environment 300 may take the form of a container-based architecture, such as Kubernetes or Docker, for example.

As discussed in further detail below, and in contrast with the configurations shown in FIGS. 1 and 2, the service 306 may use a user token when requesting service account authentication. Further, the IAM identity provider 310 may implement a token adapter 310a, and authentication 310b for a service account, in response to receipt of an authentication request, which may include a user token, from the service 306. As well, the service 308 may be operable to generate a single token that includes both a user profile and a service profile. Like the other tokens disclosed herein, that single token may take the form of a JWT, but that is not required. That single token may be passed to the service 306 and combined, by the service 306, with an API call and sent to the service 308. The service 308 may be configured to validate that single token before performing any functions associated with the call received from the service 306.

It is noted that as used herein, a user token, and a service token, need not take any particular form, nor include any particular information. In one example implementation, a user token, such as ‘User JWT’ for example, may contain authenticated user information, user roles and an “aud” claim that identifies a web application 304, such as ‘Web App,’ as the audience, or intended recipient, of the user token. Further, in one example implementation, a service token, such as ‘Service JWT’ for example, may contain service 306 information, roles and an “aud” claim that identifies the service 306 as the audience, or intended recipient, of the service token.

### B.1 Authentication for Service Account Using a User Token

With more particular reference now to the custom authentication for service account functionality 310b, such functionality may augment the IAM identity provider 310 functionality to add a custom authenticator for service account which may require a user token, such as a user JWT access token, as an input (8) from the service 306, in addition to service information/credentials such as a ClientId and a ClientSecret.

As part of a service account authentication process performed by the IAM identity provider 310 at the request of the service 306, if the user token, such as User JWT, is provided (8) by the service 306, then the IAM identity provider 310 may validate that the user token is not expired, and/or is otherwise valid. Further, the IAM identity provider 310 may also check if the user session is still active. If the user is logged off or login session expired, then the IAM identity provider 310 may fail the validation of user token. Otherwise, the IAM identity provider 310 may then, upon successful validation of the user token, sign the user token, which may render the user token tamperproof. If the IAM identity provider 310 is not able to validate the user token for some reason, the IAM identity provider 310 may fail the authentication. If no user token is provided (8) by the service 306, the IAM identity provider 310 may simply perform a validation process on the service token, such as the validation processes disclosed in the respective examples of FIGS. 1 and 2.

With reference to the previous discussion concerning authentication for a service account, the service 306 may employ the OAuth2 client credential flow for login but may pass (8) an additional parameter, namely, the user access token, to the IAM identity provider 310. In response, and as described in more detail below, the service 306 may receive (9), from the IAM identity provider 310, a token that includes both a user profile and a service profile needed for authorization.

### B.2 Token Adapter

By way of background, and with reference to (6) of FIG. 3a, the web app 304 may call (6) the service 306 with a [user] token. In response, the service 306 may validate (7) whether the user 302 is allowed to call the service 306 API. As well, if the service 306 requires further processing, such as by the service 308 for example, to respond to the web app 304 API request, the service 306 may request (8) service account authentication using the user token. If the request (8) is successfully authenticated by the authentication 310b, the JWT adapter 310a may generate an access token, and return (9) the access token to the service 306, as described below.

Particularly, a token adapter, such as the JWT adapter 310a, may, while constructing a service token such as Service JWT for example, merge user token information, roles, and claims, for example, together with the service token. The resulting single token, such as a ‘User+Service JWT’ for example, may then include both the user profile and the service profile needed for authorization. The resulting single token, which includes both the service profile and a user profile, may be digitally signed by the IAM 310 to avoid tampering with that single token. In some embodiments, the digitally signed token may also be encrypted by the JWT adapter 310, such as by way of a public-private key combination in which one of the JTW adapter 310a and the service 306 holds one of the keys, and the other holds the other key. The access token may be transmitted (9) by the IAM identity provider 310 to the service 306.

### B.3 Validate Access Token, Such as [User+Service] JWT

When the token, such as an access token has been received (9) by the service 306 from the IAM identity provider 310, the service 306 may then transmit (10) an API call, along with the access token, to the service 308. In some embodiments, the service 306 may use an authorization protocol such as OAuth2 (see https://oauth.net/2/) client credential flow, for login but may pass the additional parameter, namely, the access token, to the service 308.

Particularly, and with continued reference to FIG. 3a, the service 306 may, after receiving (9) the [user+service] token from the IAM identity provider 310, then call (10) the service 308 API, using the [user+service] token. The service 308 may then validate (11) the [user+service] token to confirm that the [user+service] token has not expired, and has not been tampered with. If the user profile is not present in a token sent from the service 306 to service 308, the service 308 may only validate the service token.

### B.4 Refresh Access Token, Such as [User+Service] JWT

Turning next to FIG. 3b, an example refresh access token process may proceed generally as follows. By way of introduction, some embodiments may provide that an access token may be relatively short lived, such as about 5 minutes for example, while a refresh token may have a relatively longer life, such as about 30 minutes for example. If there is an ongoing need for a service, but the access token has expired, there may be a need to generate and use a refresh token.

Initially, the service 306 may use an OAuth2 client credential flow for login but pass additional parameter to the service 308, namely, an access token such as “User+Service JWT.” As part of service account authentication, if user token is provided then: (i) validate “user+service token” is not expired and is not tampered with; (ii) validate “aud” claim to be “Service 1”; and (iii) in case of issues with those validation, fail the authentication otherwise pass authentication. If a user token is not provided, then only the service token may be validated.

In more detail, and with continued reference to FIG. 3b, if the service 306 has to call service 308 again for another API call and the access token is expired, then the service 306 may have to get a new access token from IAM 310. FIG. 3b shows an example refresh token flow, which may be similar to the authentication flow (8) of FIG. 3a.

Thus, when the access token is expired, the service 306 may issue a refresh token request (12) to the IAM identity provider 310 to refresh the access token. In response to the request (12), the IAM identity provider may generate a new token, which may be referred to as a refresh token, and then transmit (13) the refresh token to the requesting service 306. The refresh token may comprise a renewed user token, a renewed service token, and a renewed id token.

Note that even though the access token at service 306 may be expired the refresh token may still be valid. Both the access token and the refresh token may contain the user profile. Thus, in response to a refresh request (12), the IAM identity provider 310 may be able to examine the original refresh token to get the user profile and to validate the user session before re-issuing (13) the access token. The service 306 now has a new access token [user+service] and is ready to make a second API call (14) to the API of service 308, or another service. After receipt of the second API call (14) from the service 306, the service 308 may perform a validation process (15) on the new access token that was received from the service 306 in conjunction with the second API call (14).

### B.5 Calling Services and Called Services

As noted herein, for example in the discussion of FIG. 3a, a service, such as service 306 may be referred to as a calling service, and a service, such as service 308 which is called by another service, may be referred to as a called service. There is no limit to the number of services that may be called directly and/or indirectly by the service 306. For example, the service 306 may call service 308, and the service 308 may in turn call another service, which may call another service, and so forth without limit. Thus, the initial call by the service 306 may result in a series of service calls, or service calls made in a serial fashion. Further, the service 306 may additionally, or alternatively, call one or more other services besides service 308. That is, the service 306 may make any number of parallel service calls to respective services. More generally, any service may be the subject of, and/or issue, one or more serial service calls and/or one or more parallel service calls. Thus, there is no practical end to the complexity, number, and types, of service calls that may be made in any particular embodiment.

### C. Aspects of Example Tokens

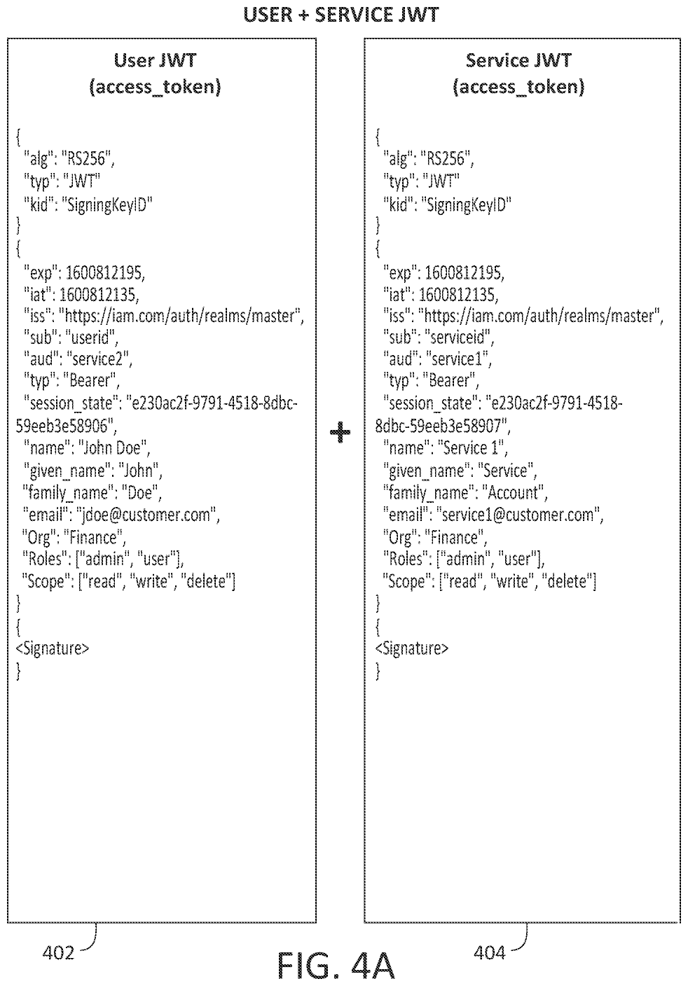

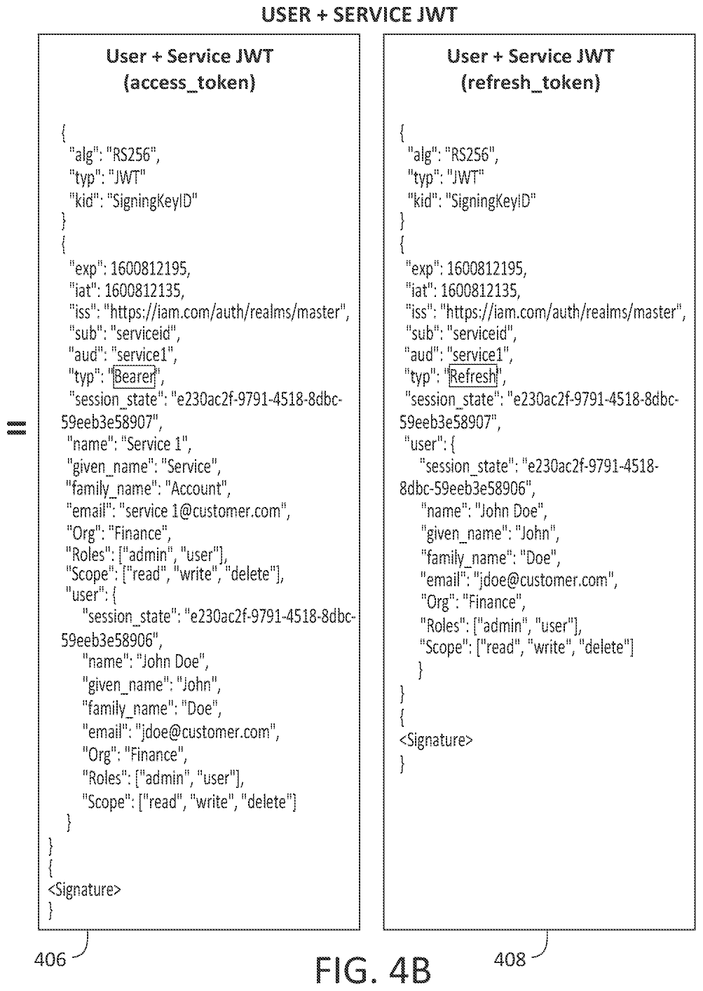

With reference next to FIGS. 4a and 4b, various aspects of some example tokens are disclosed. In general, reference is made herein to a variety of different tokens. As noted, an JWT token generated by an IAM identity provider may contain multiple tokens including, for example, an access token, a refresh_token, and an id_token. Example access tokens include, but are not limited to, a [user] token, and a [user+service] token.

Particularly, portions of a user token 402 and a service token 404 (FIG. 4a) may be combined together to generate an access token 406 (FIG. 4b) that includes one or more elements of each of the user token 402 and service token 404. As well, portions of the user token 402 and the service token 404 may be combined together to generate a refresh token 408 (FIG. 4b) that includes one or more elements of each of the user token 402 and service token 404.

In more detail, information and data such as user claims, one example of which is an “aud” claim, from the token 402 may be copied to the refresh token 408 to preserve that information and data, which may be included again in the access token 406 during a grant_type=refresh_token operation. In some embodiments, the access token 406 may be short lived, 5 minutes for example, while the refresh token 408 may be relatively long lived, 30 minutes for example, and may be used to get a new access token 402 for the next API call without prompting the user to login.

### D. Aspects of an Example Service Account Authentication Process

Following is a listing of operations, rendered in the form of an algorithm, of an example process for service account authentication such as is indicated at (8) in FIG. 3a, where service account authentication is performed using a user token.

1(a) Login: Get Access Token

$curl -H “Content-Type: application/x-www-form-urlencoded” -X POST -d
‘grant_type=client_credentials&client_id=service1&client_secret=5235ae96-1c0a-4d3f-
a944-8d09719ba848&user_token=<access_token>’
https://iam.com/auth/realms/master/protocol/openid-connect/token

1(b) Authentication Logic at IAM—Client Credentials

```
  [client credential authentication follows here]
  [Generate “Service JWT”]
  If optional parameter “user_token” is present then
  If “user_token” == “User Access Token” then
    Validate “User Access Token”, fail auth if invalid
    Merge claims from “User Access Token” into “Service JWT” // copy user
  claims in both access_token and refresh_token
    [audit log to indicate that it was first service account call on behalf of
  user]
    End
  Else If “user_token” == “Service1 Access Token” then // It could be service1,
service2, service3 etc. access token for repeated chain of API calls
  Validated “Service 1 Access Token”, fail auth if invalid
  If “Service1 Access Token” contains “User” object then
    Validate “User” object session_state to ensure such a user is logged-in
    Merge “User” object from “Service1 Access Token” into “Service JWT” //
  copy user claims in both access_token and refresh_token
  [audit log to indicate that it was next service account call on behalf of user
forming a chain of API calls]
  End
  End
  Sign “Service JWT”
  Return “Service JWT”
  2(a) Login: Refresh Expired Access Token
    $curl -H “Content-Type: application/x-www-form-urlencoded” -X POST -
  d ‘grant_type= refresh_token&client_id=service1&client_secret=5235ae96-
  1c0a-4d3f-a944-8d09719ba848&refresh_token=<refresh_token>’
  https://iam.com/auth/realms/master/protocol/openid-connect/token
```

2(b) Authentication Logic at IAM—Refresh Token

```
[refresh token authentication follows here]
[verify the “aud” claim of refresh_token to match with “clientId”]
[Generate “Service JWT”]
If “refresh_token” contains “User” object then
  Validate “User” object session_state to ensure such a user is logged-in
  Merge “User” object from “Refresh Token” into “Service JWT” // copy
user claims in both access_token and refresh_token
  [audit log to indicate that it was next service account call on behalf of
user forming a chain of API calls]
End
Sign “Service JWT”
Return “Service JWT”
```

### E. Further Discussion

As disclosed herein, example embodiments may implement a variety of useful features and functionalities. For example, an embodiment may implement and use a cryptographically signed token, such as a JWT for example, containing both user and service account profiles/claims. The use of such tokens may be repeatable for API calls from one service to another to any depth. The user profile may be securely preserved for every service account authentication.

As another example, an embodiment may enable auditing at an IAM level to know which service account was used by which user. For example, an IAM identity provider may track service account authentication requests that it receives.

Further, embodiments may be compatible with the OAuth2 protocol. An embodiment may securely extend that protocol to connect user session to service account session. This approach may enable secure authentication of a user. As well, this approach may provide verification of “aud” claims for refresh token flow to prevent attacks, such as a man-in-the-middle attack. Finally, such embodiments may provide verification of a “session state” claim from user access token to ensure an authorized user is logged-in, and impersonation by a bad actor may fail after user logs out/times out.

Embodiments may address the challenges that may be associated with an expired user token. For example, and as noted herein, expired tokens may otherwise be employed by bad actors to gain access to a service.

As another example, an embodiment may enable preservation of solution specific custom claims for a user and a service account in the merged JWT. That is, such claims may be preserved in an access token that includes a user profile and a service profile.

Further, an embodiment may implement dual authorization, of both a user and a service, using a merged JWT, that is, an access token. Particularly, an embodiment may address various use cases such as, but not limited to, from scope-based authorization (SBAC), role-based authorization (RBAC) and attribute-based authorization (ABAC). As well, such embodiments may provide for consistent validation of tokens.

As a final example, embodiments may provide for a consistent experience with an API gateway or other layers on top of backend microservices. That is, regardless of what other components or services may be layered on the backend microservices, embodiments of the invention may operate to implement the disclosed authentication processes.

### F. Example Methods

It is noted with respect to the example methods of FIG. 1-5 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

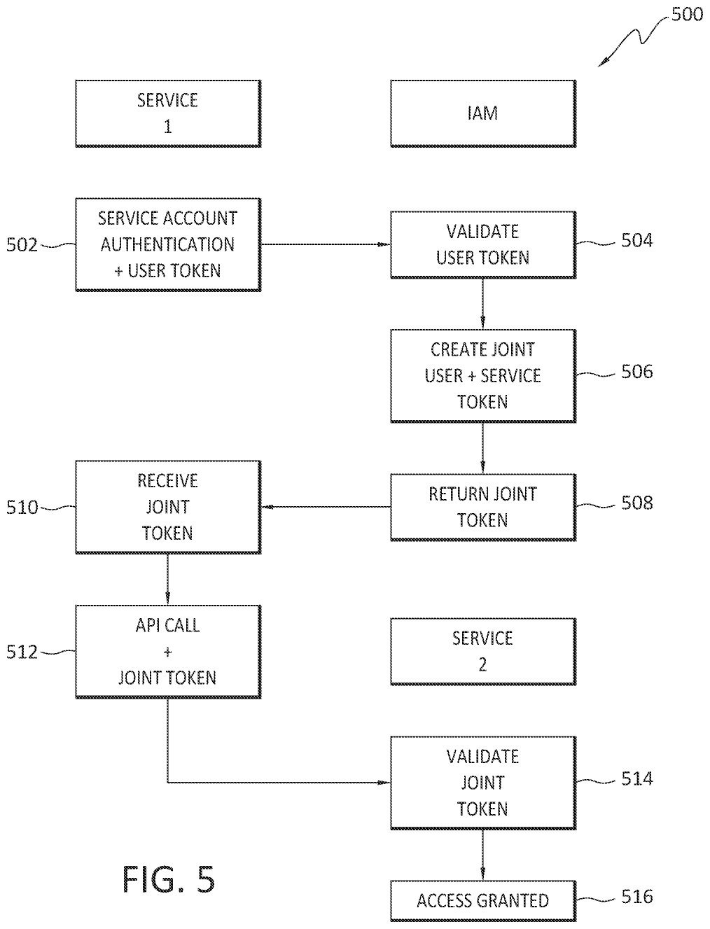

Directing attention now to FIG. 5, aspects of an example authentication method 500 are disclosed. In some embodiments, the method 500 may be performed by a group of entities comprising an IAM identity provider, a calling service, and a called service, although the scope of the invention is not limited to these entities, nor to this particular group.

The method 500 may begin when a service1 sends a request 502 to an IAM identity provider. The request 502 may be a request for service account authorization that identifies a service to which a user has requested access, and the request 502 may include a user token received, by the service1, from a user by way of, for example, a containerized web application that is operable to communicate with service1. The user token may have been validated by the service1 prior to the request 502. The request 502 may also include a service token that corresponds to the service to which the user has requested access.

The IAM identity provider may receive and validate 504 the user token. For example, the IAM identity provider may check to ensure the user token has not expired and, if not, the IAM identity provider may digitally sign the user token. If the validation 504 is successful, the IAM identity provider may create a single access token 506 that includes both the user token or user profile, and the service token or service profile. The access token may then be returned 508 and received 510 by the service1.

The service1 may then issue 512 an API call, along with the access token, to a service 2. The service2 may thus be an example of a service called by service1. As such, the service2 may comprise a called service, and service1 may comprise a calling service. After receipt of the access token from the service1, the service2 may then perform a validation process 514 on the access token. If the validation process 514 is successful, the user may be granted access 516 to service2.

### G. Further Example Embodiments

Following are some further example embodiments of the invention. These are presented only by way of example and are not intended to limit the scope of the invention in any way.

Embodiment 1. A method, comprising: receiving, by an identity and access management module, a request from a first service to validate a user token, and the request includes a service token; performing, by the identity and access management module, a validation process on the user token; when the validation process is successful, generating, by the identity and access management module, an access token that includes the user token and the service token; and transmitting, by the identity and access management module to the first service, the access token, wherein the access token is usable by the first service to gain access to a second service upon successful validation, by the second service, of the access token.

Embodiment 2. The method as recited in embodiment 1, wherein the request is associated with the user token and an API call received by the first service from a containerized application.

Embodiment 3. The method as recited in any of embodiments 1-2, wherein one or both of the first service and the second service comprise a respective microservice operable to carry out respective functions of a containerized application.

Embodiment 4. The method as recited in any of embodiments 1-3, wherein, prior to receipt of the request, the identity and access management module performs a user authentication process at a request of an application that has received an access request from a user.

Embodiment 5. The method as recited in embodiment 4, wherein the request by the application includes the user token.

Embodiment 6. The method as recited in any of embodiments 1-5, wherein the user token includes a user profile.

Embodiment 7. The method as recited in any of embodiments 1-6, wherein the service token includes a service profile.

Embodiment 8. The method as recited in any of embodiments 1-7, wherein the identity and access management module validation process comprises checking the user token to determine if the user token is expired.

Embodiment 9. The method as recited in any of embodiments 1-8, wherein the identity and access management module validation process comprises checking the user token to determine if the user token is expired and, when the user token is expired, creating a refresh token for a user, on whose behalf the request was sent by the first service, when one or more criteria are met.

Embodiment 10. The method as recited in embodiment 9, wherein the refresh token enables the user to have continued access to the second service without having to login to a web application which initially received the user token from the user.

Embodiment 11. A non-transitory storage medium having stored therein instructions that are executable by one or more hardware processors to perform operations comprising the operations of any one or more of embodiments 1-10.

Embodiment 12. A system for performing any of the operations, methods, or processes, or any portion of any of these, disclosed herein.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

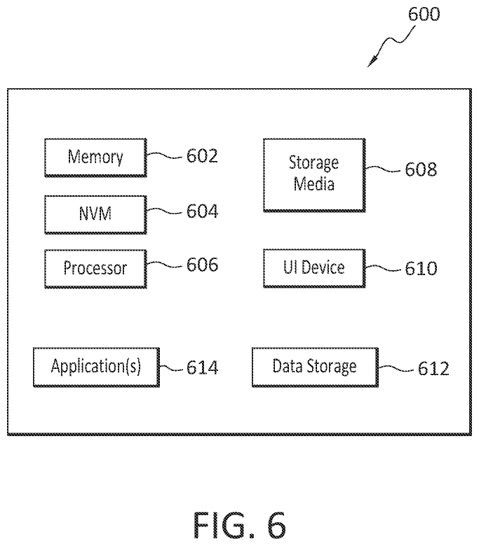

With reference briefly now to FIG. 6, any one or more of the entities disclosed, or implied, by FIGS. 1-5 and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by an identity and access management module, a request from a first service to validate a user token, and the request includes a service token;
performing, by the identity and access management module, a validation process on the user token;
when the validation process is successful, generating, by the identity and access management module, an access token that includes the user token and the service token; and
transmitting, by the identity and access management module to the first service, the access token, wherein the access token is usable by the first service to gain access to a second service upon successful validation, by the second service, of the access token.

2. The method as recited in claim 1, wherein the request is associated with the user token and an API call received by the first service from a containerized application.

3. The method as recited in claim 1, wherein one or both of the first service and the second service comprise a respective microservice operable to carry out respective functions of a containerized application.

4. The method as recited in claim 1, wherein, prior to receipt of the request, the identity and access management module performs a user authentication process at a request of an application that has received an access request from a user.

5. The method as recited in claim 4, wherein the request by the application includes the user token.

6. The method as recited in claim 1, wherein the user token includes a user profile.

7. The method as recited in claim 1, wherein the service token includes a service profile.

8. The method as recited in claim 1, wherein the identity and access management module validation process comprises checking the user token to determine if the user token is expired.

9. The method as recited in claim 1, wherein the identity and access management module validation process comprises checking the user token to determine if the user token is expired and, when the user token is expired, creating a refresh token for a user, on whose behalf the request was sent by the first service, when one or more criteria are met.

10. The method as recited in claim 9, wherein the refresh token enables the user to have continued access to the second service without having to login to a web application which initially received the user token from the user.

11. A non-transitory storage medium having stored therein instructions that are executable by one or more hardware processors to perform operations comprising:
receiving, by an identity and access management module, a request from a first service to validate a user token, and the request includes a service token;
performing, by the identity and access management module, a validation process on the user token;
when the validation process is successful, generating, by the identity and access management module, an access token that includes the user token and the service token; and
transmitting, by the identity and access management module to the first service, the access token, wherein the access token is usable by the first service to gain access to a second service upon successful validation, by the second service, of the access token.

12. The non-transitory storage medium as recited in claim 11, wherein the request is associated with the user token and an API call received by the first service from a containerized application.

13. The non-transitory storage medium as recited in claim 11, wherein one or both of the first service and the second service comprise a respective microservice operable to carry out respective functions of a containerized application.

14. The non-transitory storage medium as recited in claim 11, wherein, prior to receipt of the request, the identity and access management module performs a user authentication process at a request of an application that has received an access request from a user.

15. The non-transitory storage medium as recited in claim 14, wherein the request by the application includes the user token.

16. The non-transitory storage medium as recited in claim 11, wherein the user token includes a user profile.

17. The non-transitory storage medium as recited in claim 11, wherein the service token includes a service profile.

18. The non-transitory storage medium as recited in claim 11, wherein the identity and access management module validation process comprises checking the user token to determine if the user token is expired.

19. The non-transitory storage medium as recited in claim 11, wherein the identity and access management module validation process comprises checking the user token to determine if the user token is expired and, when the user token is expired, creating a refresh token for a user, on whose behalf the request was sent by the first service, when one or more criteria are met.

20. The non-transitory storage medium as recited in claim 19, wherein the refresh token enables the user to have continued access to the second service without having to login to a web application which initially received the user token from the user.
